(19) United States
(12) Patent Application Publication
(10) Pub. No.: US 2023/0201070 A1
(43) Pub. Date: Jun. 29, 2023

(54) MASSAGE DEVICE

(71) Applicants: Hyundai Motor Company, Seoul (KR); Kia Corporation, Seoul (KR); JAHWA ELECTRONICS CO., LTD., Cheongju-si (KR); Hyundai Transys Inc., Seosan-si (KR)

(72) Inventors: Sang Hark Lee, Incheon (KR); Sang Do Park, Suwon-si (KR); Deok Soo Lim, Hwaseong-si (KR); Jung Sang You, Hwaseong-si (KR); Ho Suk Jung, Hwaseong-si (KR); Chan Ho Jung, Gunpo-si (KR); Sang Soo Lee, Hwaseong-si (KR); Jong Soo Ryu, Cheongju-si (KR); Sang Gyu Byeon, Cheongju-si (KR); Hyun Gyu Sung, Cheongju-si (KR); Hyun Seok Song, Hwaseong-si (KR); Beom Sun Kim, Hwaseong-si (KR)

(21) Appl. No.: 17/969,452

(22) Filed: Oct. 19, 2022

(30) Foreign Application Priority Data
Dec. 27, 2021 (KR) 10-2021-0187942

(51) Int. Cl. A61H 15/00

(52) U.S. Cl. CPC A61H 15/0078; A61H 2201/0149; A61H 2205/081; A61H 2201/1669; A61H 2015/0028

(57) ABSTRACT

Proposed is a massage device which can be installed on a seat. The massage device includes a striking unit, a driving unit providing a driving force for driving the striking unit, and an operation unit configured to convert a rotation force provided by the driving unit into a linear motion to linearly move the striking unit.

### CROSS-REFERENCE TO RELATED APPLICATIONS

This application claims the benefit of Korean Patent Application No. 10-2021-0187942, filed on Dec. 27, 2021, which application is hereby incorporated herein by reference.

### TECHNICAL FIELD

The present disclosure relates a massage device and, more particularly, to a massage device which can be installed on a seat.

### BACKGROUND

Massage has been widely used since old times to relieve body fatigue and help blood flow by kneading, pressing or tapping the body. In recent years, in addition to the massage provided by a massagist, various massage machines have been developed so that massage by a device is also used.

In a limited space, such as the inside of a vehicle, the human body moves less. Besides, as driving time increases, fatigue builds up on a driver or an occupant. Accordingly, a massage device is applied to a vehicle, such as a vehicle seat.

For example, a massage device using an air cell or a cylinder-type DC motor is installed in a seat. Since such a massage device lacks speed and strength, it does not sufficiently function as a massage device.

### SUMMARY

The present disclosure has been made in an effort to solve the above problem, and an object of the present disclosure is to provide a massage device capable of providing an excellent massage function.

The object of the present disclosure is not limited to the aforementioned object, and other objects not mentioned can be clearly understood to those skilled in the art to which the present disclosure pertains (hereinafter referred to as ‘those skilled in the art’) from the following description.

In order to achieve the object of the present disclosure, an embodiment of the present disclosure provides a massage device including: a striking unit; a driving unit providing a driving force for driving the striking unit; and an operation unit configured to convert a rotation force provided by the driving unit into a linear motion to linearly move the striking unit.

In order to achieve the object of the present disclosure, another embodiment of the present disclosure provides a massage device mounted in a seat of a vehicle, including: a striking unit; a driving unit providing a driving force for driving the striking unit; an operation unit configured to convert a rotation force provided by the driving unit into a linear motion to linearly move the striking unit; and a controller configured to supply power to the driving unit and control a rotation speed of the driving unit on the basis of an input from a user or collected vehicle speed information of the vehicle.

According to the present disclosure, a massage device which provides an excellent massage functionality is provided.

The effect of the present disclosure is not limited to the aforementioned effect, and other effects not mentioned can be clearly recognized to those skilled in the art from the following description.

### BRIEF DESCRIPTION OF THE DRAWINGS

FIG. 1A is a perspective view of one side of a massage device according to some embodiments of the present disclosure.

FIG. 1B is a perspective view of another side of the massage device according to some embodiments of the present disclosure.

FIG. 2 is a front view of FIGS. 1A and 1B.

FIG. 3 is a front view of a massage device according to some embodiments of the present disclosure.

FIG. 4 illustrates the rotation axes of a drive shaft and an eccentric shaft of a driving unit of the massage device according to the present disclosure.

FIG. 5 shows an operation system of the massage device according to the present disclosure.

FIGS. 6A to 6D illustrate the operation of the massage device according to embodiments of the present disclosure.

FIG. 7 is a side view of the massage device according to some embodiments of the present disclosure.

FIG. 8 illustrates the massage device of the present disclosure mounted to a seat.

FIG. 9 illustrates the massage device of the present disclosure mounted to a seat frame of FIG. 8.

FIG. 10 illustrates a massage part of the massage device of the present disclosure when a person is seated on a seat in the case of FIG. 9.

FIGS. 11 and 12 illustrate the massage device of the present disclosure mounted according to various mounting ways.

### DETAILED DESCRIPTION OF ILLUSTRATIVE EMBODIMENTS

Specific structural or functional descriptions presented in exemplary embodiments of the present disclosure are only exemplified for the purpose of describing the exemplary embodiments according to the concept of the present disclosure, and the exemplary embodiments according to the concept of the present disclosure can be carried out in various forms. In addition, the exemplary embodiments should not be interpreted as being limited to the exemplary embodiments described in the present specification, and should be understood as including all modifications, equivalents, and substitutes included in the spirit and technical scope of the present disclosure.

Meanwhile, in the present disclosure, terms such as first and/or second can be used to describe various components, but the components are not limited to the terms. The terms are used only for the purpose of distinguishing one component from other components, but for example, a first component can be referred to as a second component, and similarly, the second component can also be referred to as the first component, without departing from the scope according to the concept of the present disclosure.

When a component is referred to as being “connected” or “coupled” to another component, it should be understood that the components can be directly connected or coupled to each other, but still another component can also exist therebetween. On the other hand, when a component is referred to as being “directly connected to” or “in direct contact with” another component, it should be understood that another component does not exist therebetween. Other expressions for describing the relationship between components, that is, expressions such as “between” and “directly between” or “adjacent to” and “directly adjacent to” should be also interpreted in the same manner.

Throughout the specification, the same reference numerals refer to the same elements. The terms used in the present specification are for the purpose of describing the exemplary embodiments and are not intended to limit the present disclosure. In the present specification, the singular form also includes the plural form unless otherwise specified in the phrase. “Comprises” and/or “comprising” used in the specification specifies the presence of the mentioned component, step, operation, and/or element, and does not exclude the presence or the addition of one or more other components, steps, operations, and/or elements.

Hereinafter, various exemplary embodiments of the present disclosure will be described in detail with reference to the accompanying drawings.

According to the present disclosure, by providing a massage device to which a striking method is applied, it is possible to improve blood flow in the pelvis, waist, etc., of a seat occupant and ultimately effectively reduce the fatigue of the seat occupant.

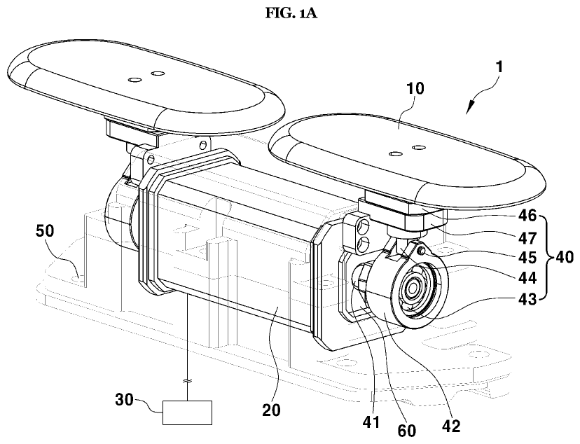

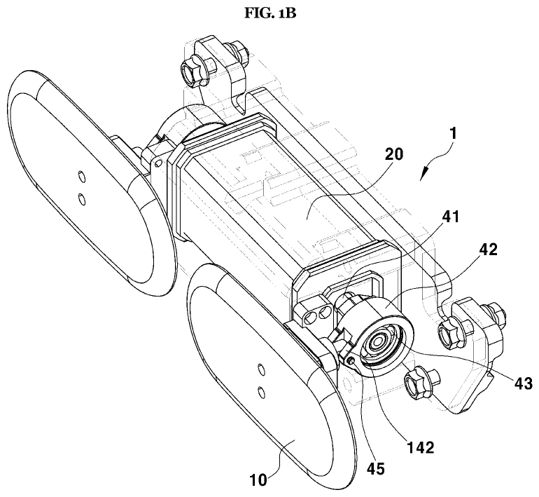

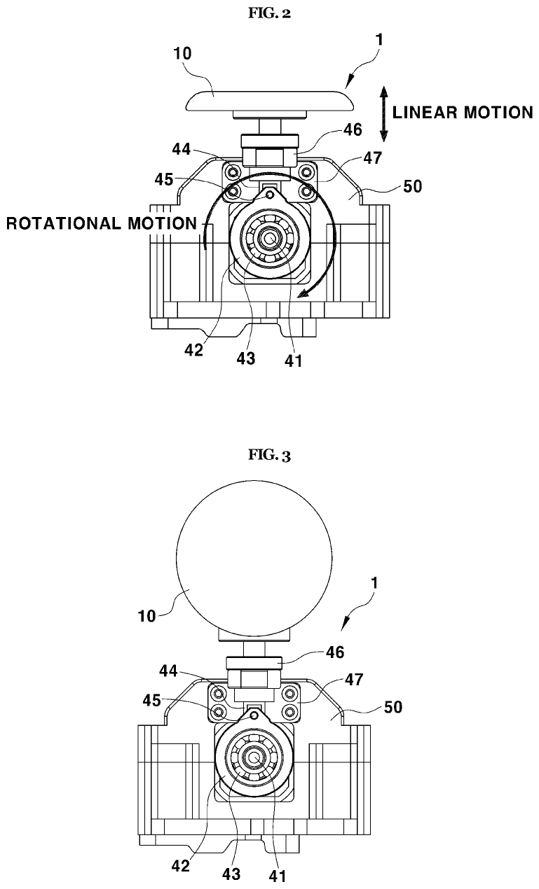

FIGS. 1A, 1B and 2 illustrate a massage device 1 according to an embodiment of the present disclosure. According to an implementation of the present disclosure, the massage device 1 includes a striking unit 10, a driving unit 20, a power unit 30 and an operation unit 40.

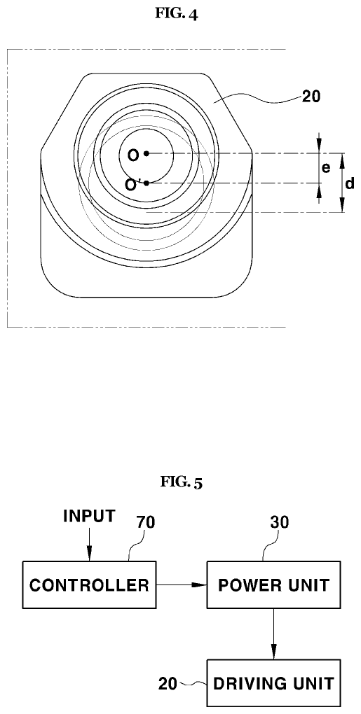

The striking unit 10 directly provides a massage. The striking unit 10 may provide a massage to a target part through a striking motion. The striking unit 10 may have various shapes. As illustrated in FIGS. 1A, 1B, and 2, in an implementation, the striking unit 10 is formed as a flat plate. As illustrated in FIG. 3, in an implementation, the striking unit 10 is formed as a sphere. The shape of the striking unit 10 is not limited to a flat plate or a sphere, and thus, the striking unit 10 may be formed as other shapes. Since the striking unit 10 may be formed as various shapes as described above, a massage sensation property may be set differently.

The driving unit 20 provides a driving force for the striking unit 10 to execute a striking motion. In an implementation, the driving unit 20 is a direct current (DC) motor. In an implementation, the driving unit 20 is a brushless direct current (BLDC) motor. In particular, when a brushless DC motor is used, a frequency and a displacement may be finely adjusted. The driving unit 20 may be supplied with power from the power unit 30 which supplies power.

The operation unit 40 performs a function of converting a driving force by the driving unit 20 into a striking motion of the striking unit 10. According to an implementation of the present disclosure, the operation unit 40 may include an eccentric shaft 41, a tubular part 42, a bearing 43, a slide shaft 44, a pin member 45, a guide 46 and a fixture 47.

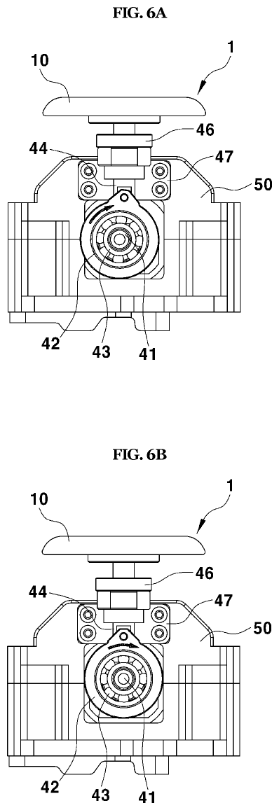

As illustrated in FIG. 4, the eccentric shaft 41 has a center O at a position separated by a predetermined distance from a center O′ of a drive shaft of the driving unit 20. That is to say, the center O of the eccentric shaft 41 is configured to rotate about the center O′ of the drive shaft at a position moved by an eccentric distance e from the center O′ of the drive shaft. Accordingly, the striking unit 10 may rise or fall by a distance d for one rising or falling stroke. This will be described below in detail.

The tubular part 42 is coupled to an end of the eccentric shaft 41. The tubular part 42 is connected to the eccentric shaft 41 to convert a rotational motion of the eccentric shaft 41 into a vertical motion. In an implementation, the bearing 43 may be interposed between the eccentric shaft 41 and the tubular part 42. The bearing 43 performs a driving role so that an eccentric rotation is smoothly carried out.

The slide shaft 44 is connected to the tubular part 42. One end of the slide shaft 44 is connected to the tubular part 42, and the other end of the slide shaft 44 is connected to the striking unit 10. The slide shaft 44 performs a function of transferring a vertical motion of the tubular part 42 to the striking unit 10.

Coupling portions 142 are defined on the tubular part 42. The slide shaft 44 is connected to the coupling portions 142. In an implementation, the coupling portions 142 are portions which project radially outward of the tubular part 42 at both ends of the tubular part 42, and the slide shaft 44 is inserted and fixed between the coupling portions 142. In an implementation, the pin member 45 may be coupled through the coupling portions 142 and the slide shaft 44.

The guide 46 is defined on the outer circumference of the slide shaft 44. In an implementation, the guide 46 is a linear bushing. The guide 46 performs a function of guiding an upward and downward motion of the slide shaft 44. The guide 46 may be fixed to the massage device 1, and the slide shaft 44 may linearly move in the guide 46. In an implementation, the guide 46 is fixed by the fixture 47. The fixture 47 may be fixedly coupled to the casing of the driving unit 20 or a housing 50 of the massage device 1. The fixture 47 may include the guide 46 therein to fix the guide 46.

The massage device 1 may further include the housing 50. The housing 50 accommodates the driving unit 20, and mounts the striking unit 10 and the operation unit 40. In addition, the housing 50 may mount the massage device 1 to a mounting target.

According to an embodiment, a damping member 60 is defined. The damping member 60 may be disposed between the driving unit 20 and the housing 50 to reduce the vibration generated in the driving unit 20. In an implementation, the damping member 6o may be made of a rubber material.

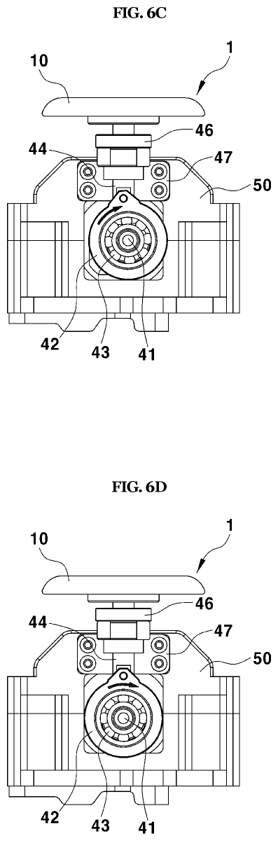

As illustrated in FIG. 5, the massage device 1 according to the present disclosure may further include a controller 70. The controller 70 is configured to control the power supply of the power unit 30 and adjust a rotation speed of the driving unit 20. The controller 70 may control the power unit 30 according to a user input to supply power and cut off power supply to the massage device 1 or the driving unit 20. Also, the controller 70 may adjust the rotation speed of the driving unit 20 according to a user input. When the rotation speed of the driving unit 20 is adjusted, the number of operations per hour of the striking unit 10 may be changed. This enables determination of, a vibration frequency that is transferred to the user, and a massage strength may be adjusted.

The controller 70 may be configured to be able to communicate with the external devices and systems. For example, the controller 70 is configured to be able to communicate with a vehicle including a seat on which the massage device 1 is installed. According to an implementation of the present disclosure, the controller 70 is configured to be able to communicate with a driver assistance system of a vehicle, such as a vehicle lane departure warning system and a front/rear collision avoidance system. When occurrence of a dangerous situation is recognized by the driver assistance system, the controller 70 may drive the massage device 1 to more effectively inform the occurrence of the dangerous situation. Furthermore, in an example, the controller 70 is configured to collect vehicle speed information of a vehicle. The controller 70 may adjust a rotation speed of the driving unit 20 on the basis of the collected vehicle speed information. By adjusting a rotation speed of the driving unit 20 on the basis of rotation speed information of the driving unit 20 defined in advance according to vehicle speed conditions, the controller 70 controls the massage performance felt by a seat occupant to be maintained the same.

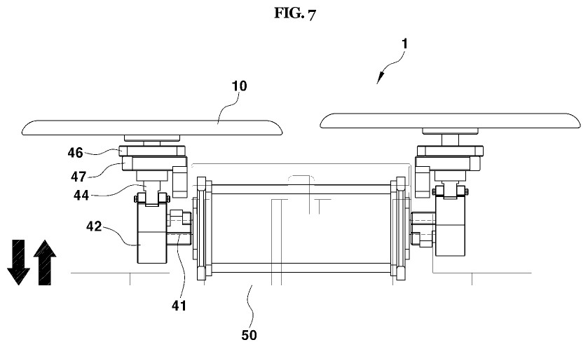

The operation of the massage device 1 will be described below with reference to FIGS. 6A to 6D. When power is applied to the driving unit 20 by the power unit 30, the drive shaft rotates (FIG. 6A). Then the eccentric shaft 41 and the tubular part 42 which are connected to the drive shaft rotate together, and the eccentric rotational motion of the eccentric shaft 41 is converted into a linear motion by the tubular part 42 and the slide shaft 44. As the rotation of the eccentric shaft 41 raises the slide shaft 44, the striking unit 10 is raised to a highest point in the position of the striking unit 10 (FIG. 6B). In succession, the eccentric shaft 41 rotates to lower the slide shaft 44, and the striking unit 10 is lowered (FIG. 6C). The eccentric shaft 41 continues to rotate to move the striking unit 10 to a lowest point in the position of the striking unit 10 (FIG. 6D). Through this process, during the operation of the massage device 1, the striking unit 10 repeats rising and falling between the highest point and the lowest point, and performs a striking-type massage through an upward and downward motion.

The distance between the highest point and the lowest point of the striking unit 10 may be determined by the eccentric distance e between the center O′ of the drive shaft of the driving unit 20 and the center O of the eccentric shaft 41. Referring back to FIG. 4, by changing the position of the center O of the eccentric shaft 41 with respect to the center O′ of the drive shaft, the vertical displacement of the striking unit 10 may be adjusted. Since the eccentric shaft 41 rotates about the drive shaft of the driving unit 20, the vertical displacement of the striking unit 10 becomes the distance d that is twice the eccentric distance e, and the distance d corresponds to the distance between the highest point and the lowest point of the striking unit 10.

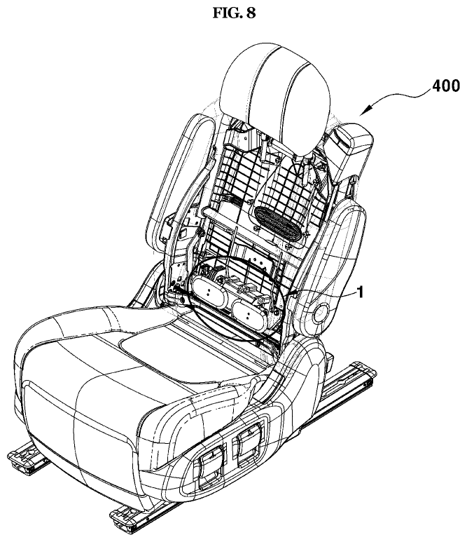

As illustrated in FIG. 7, the massage device 1 according to the present disclosure may include a plurality of striking units 10. The striking units 10 are connected to both ends, respectively, of the drive shaft of the driving unit 20. In an implementation, the respective striking units 10 may be configured to sequentially perform striking at different time points. This may be implemented by defining the mounting positions of eccentric shafts 41 at different heights on both ends of the drive shaft. For example, at the start of massage, the striking unit 10 on the left may be configured to be positioned at the lowest point, and the striking unit 10 on the right may be configured to be positioned at the highest point.

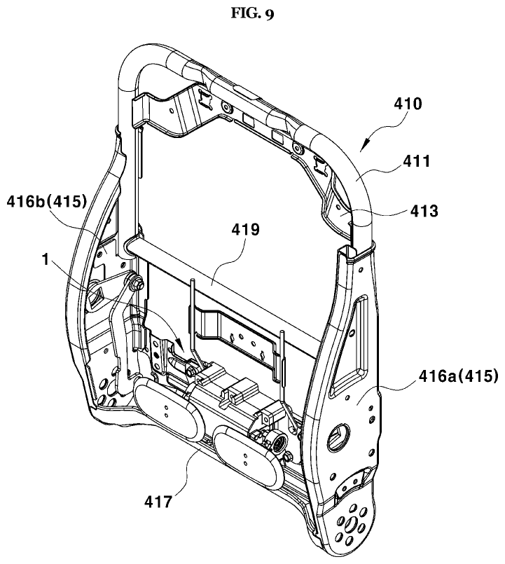

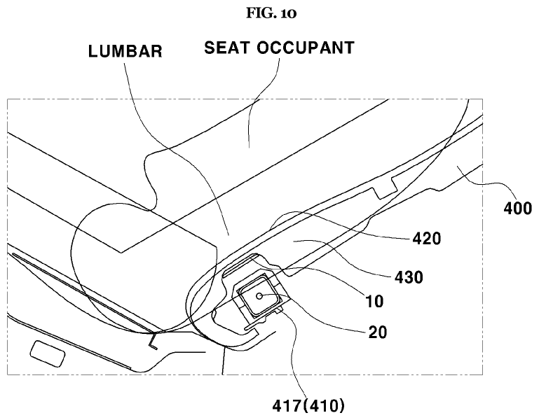

The massage device 1 of the present disclosure may be installed in a seat 400. FIG. 8 illustrates an installation example in which the massage device 1 is installed in a seat 400 of a vehicle. Specifically, referring to FIG. 9, the frame of the seat 400 of the vehicle may include a seat back frame 410, and the massage device 1 may be defined on the seat back frame 410.

Referring to FIG. 9, the seat back frame 410 includes an upper cross pipe 411, an upper cross member 413, side members 415 including an outer side member 416a and an inner side member 416b and a lower cross member 417. The seat back frame 410 selectively includes a middle cross pipe 419. The upper cross pipe 411 and the upper cross member 413 may be integrally formed if necessary, or may be separately formed.

The side members 415 are disposed on both sides, respectively, of the seat back frame 410. Both the side members 415 are connected by the lower cross member 417 at the lower ends thereof, and are connected by the upper cross pipe 411 and the upper cross member 413 at the upper ends thereof. Optionally, the middle cross pipe 419 may be horizontally disposed in the middle of the seat back frame 410 to secure rigidity. In an implementation, the massage device 1 according to the present disclosure may be mounted on the lower cross member 417 on which the lumbar of an occupant seated on the seat 400 is positioned. In another implementation, the massage device 1 may be mounted on the upper cross member 413.

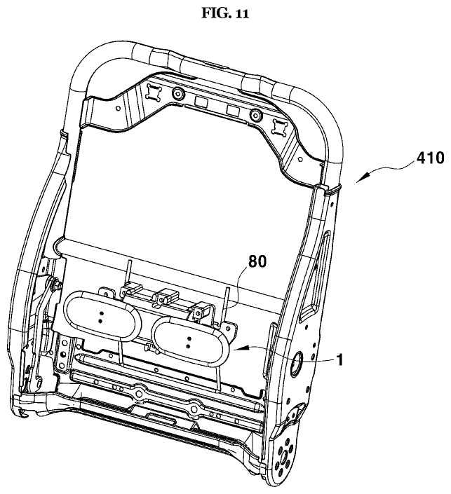

FIG. 10 illustrates the massage device 1 which is positioned on the lumbar in a state in which the occupant is seated on the seat 400. The massage device 1 may be disposed toward a seat covering 420 and a pad 430 in the seat 400, and may strike the lumbar of the seat occupant.

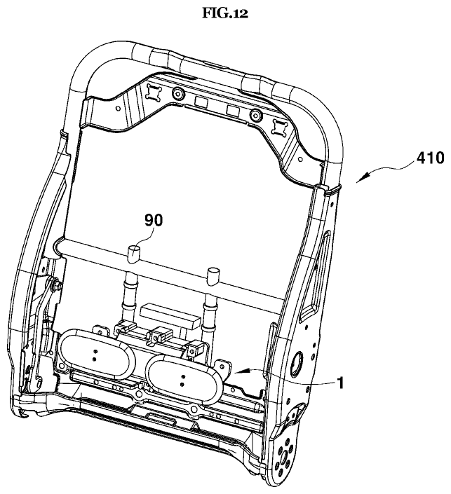

According to an embodiment of the present disclosure, the massage device 1 is configured to be movable on a mounting target or the seat back frame 410. As illustrated in FIG. 11, in an implementation, a suspension device 80 which is connected to the massage device 1 or the housing 50 may be further included. The suspension device 80 positions the massage device 1 between the middle cross pipe 419 and the lower cross member 417, and the massage device 1 may be configured to be movable up and down through the suspension device 80. The massage device 1 may be configured to be movable along the suspension device 80 on the basis of an input to the controller 70, so that a body part of the seat occupant to be massaged is increased. Alternatively, in an implementation, as illustrated in FIG. 12, the massage device 1 may be disposed between the middle cross pipe 419 and the lower cross member 417 through brackets 90. The massage device 1 may be defined to be movable along the brackets 90 according to a request of the seat occupant. Specifically, by connecting a linear movement mechanism, including slide rails, a linear motor or a linear guide, to the housing 50 or the massage device 1, the massage device 1 may be configured to be moved up and down. According to the present embodiment, as the massage device 1 is configured to be movable, a body part desired by the seat occupant may be massaged according to the seat occupant's selection, and the vehicle occupant may be massaged over a wide area.

Heretofore, it has been described that the massage device 1 according to the present disclosure is applied to a vehicle seat. However, the massage device 1 according to the present disclosure may be installed not only on the seat, footrest, legrest, headrest and other cushion parts of a vehicle but also on a seat, footrest, legrest, etc., not for a vehicle, and may be applied to an office chair or a home sofa. It is possible to provide a massage function to a chair cheaper than an existing massage chair.

According to the present disclosure, a striking-type massage device with improved massage performance is provided. In case of the existing air cell massage device, it has been known that massage strength of the air cell massage device is weak. However, according to the present disclosure, by utilizing a BLDC motor and providing striking type massage, improved massage performance is provided compared to the existing pneumatic air cell massage device.

In addition, the existing massage devices require a corrugated pipe and so forth for damping during an eccentric motion, and due to this fact, problems, such as loss of a vibration force in a vertical direction, increase in noise and disadvantages in securing a space, are caused. However, since the massage device of the present disclosure has a structure which does not require a corrugated pipe, a compact package may be provided and noise may be reduced.

The aforementioned present disclosure is not limited to the aforementioned exemplary embodiment and the accompanying drawings, and it will be apparent by those skilled in the art to which the present disclosure pertains that various substitutions, modifications, and changes can be made without departing from the technical spirit of the present disclosure.

What is claimed is:

1. A massage device comprising:
a striking device;
a driving device configured to provide a driving force for driving the striking device; and
an operation device configured to convert a rotation force provided by the driving device into a linear motion to linearly move the striking device.

2. The massage device of claim 1, wherein the operation device comprises:
an eccentric shaft disposed at an eccentric position separated by a predetermined distance from a drive shaft of the driving device, and configured to rotate about the drive shaft by an operation of the driving device; and
a slide shaft connected to the eccentric shaft and configured to linearly move according to rotation of the eccentric shaft.

3. The massage device of claim 2, further comprising:
a tubular part into which the eccentric shaft is inserted and fixed,
wherein the slide shaft is coupled to the tubular part.

4. The massage device of claim 3, wherein a bearing is disposed between tubular part and the eccentric shaft.

5. The massage device of claim 3, wherein the tubular part includes coupling portions which are on a circumference of the tubular part, and the coupling portions couple the slide shaft through a pin member.

6. The massage device of claim 3, further comprising:
a guide configured to guide movement of the slide shaft, wherein the guide surrounds the slide shaft.

7. The massage device of claim 6, wherein the guide is a linear bushing.

8. The massage device of claim 6, further comprising:
a housing configured to accommodate the driving device and fixed with respect to the driving device.

9. The massage device of claim 8, further comprising:
a fixture mounted to the housing, wherein the guide is fixed by the fixture.

10. The massage device of claim 8, wherein a damping member configured to damp vibration or noise of the driving device is arranged in the housing.

11. The massage device of claim 1, wherein the striking device is a flat plate shape or a spherical shape.

12. The massage device of claim 1, wherein the driving device includes a brushless direct current motor.

13. The massage device of claim 1, further comprising:
a power device configured to supply power to the driving device; and
a controller configured to control power supply of the power device and a rotation speed of the driving device on the basis of an input from a user.

14. A massage device mounted in a seat of a vehicle, the massage device comprising:
a striking device;
a driving device configured to provide a driving force for driving the striking device;
an operation device configured to convert a rotation force provided by the driving device into a linear motion to linearly move the striking device; and
a controller configured to supply power to the driving device and control a rotation speed of the driving device on the basis of an input from a user or collected vehicle speed information of the vehicle.

15. The massage device of claim 14, wherein the controller is configured to drive the driving device at a rotation speed preset according to the collected vehicle speed information.

16. The massage device of claim 14, wherein the massage device is mounted to a seat back frame, wherein the seat back frame comprises:
a pair of side members;
an upper cross member connecting upper ends of the pair of side members; and
a lower cross member connecting lower ends of the pair of side members, and
wherein the massage device is mounted to the upper cross member or the lower cross member.

17. The massage device of claim 16, wherein the seat back frame further comprises:
a middle cross pipe connecting middle portions of the pair of side members, and
wherein the massage device is mounted to be movable between the middle cross pipe and the lower cross member.

18. The massage device of claim 17, wherein the massage device is movably mounted between the middle cross pipe and the lower cross member by a suspension device or brackets.
